(19) United States
(12) Patent Application Publication
(10) Pub. No.: US 2017/0011456 A1
(43) Pub. Date: Jan. 12, 2017

(54) SYSTEM AND METHOD FOR AN ELECTRONIC CONSUMER DEBT EXTINGUISHMENT PROCESS

(71) Applicant: GDR Acquisition Company LLC, Wilmington, DE (US)

(72) Inventors: Mark Andrew Parsells, Wilmington, DE (US); Thomas D. VEALE, Wilmington, DE (US); Robert Wilson Brown, Middletown, DE (US)

(21) Appl. No.: 15/200,202

(22) Filed: Jul. 1, 2016

Related U.S. Application Data
(60) Provisional application No. 62/190,488, filed on Jul. 9, 2015.

(51) Int. Cl. G06Q 40/02; G06F 17/30; H04L 29/06

(52) U.S. Cl. CPC G06Q 40/02; H04L 63/102; G06F 17/30867; G06F 17/30203

(57) ABSTRACT

The “extinguishment” process and system as described herein may enable creditors, including original creditors and debt buyers, to systemically use a file containing information on multiple consumer accounts to create account-level documents along with free online consumer access to those documents, to confirm the final resolution or settlement of one or more consumer debt accounts. The automated process may protect consumers by providing account-specific evidence that can be used to demonstrate to parties such as debt collectors, creditors, credit reporting agencies or courts that a debt has been fully satisfied, e.g., paid in full, settled in full, or cancelled. This evidence is often needed in response to disputes related to attempts to collect an account that has been paid or settled due to issues such as data or timing errors by a creditor or debt collector, or is needed to challenge claims by unscrupulous or fraudulent collectors seeking to collect old debts consumers may not remember or cannot otherwise substantiate.

### CROSS-REFERENCE TO RELATED APPLICATIONS

This application claims benefit and priority to U.S. Provisional Application No. 62/190,488, filed Jul. 9, 2015, the disclosure of which is incorporated by reference herein in its entirety.

### BACKGROUND OF THE DISCLOSURE

1.0 Field of the Disclosure

The present disclosure relates to a method, a system and a computer program for electronic consumer debt extinguishment, among other features.

2.0 Related Art

Consumer debt disputes are commonplace. Often consumers are unaware of any debt issues that may be pending, such as, e.g., collection proceedings and/or balances deemed overdue or collectable. Often evidence is needed by consumers in response to disputes related to attempts to collect an account that has been paid or settled due to issues such as data or timing errors by a creditor or debt collector, or is needed to challenge claims by unscrupulous or fraudulent collectors seeking to collect old debts consumers may not remember or cannot otherwise substantiate. However, evidence may not be readily available. Moreover, there appears to be minimal centralized mechanisms to permit consumers to communicate online with debt agencies such as banks, credit card companies and the like in a manner that can facilitate a reasonably timely resolution or proof that debt has been settled.

### SUMMARY OF THE DISCLOSURE

In one aspect, the present “Extinguishment” process and system as described herein may enable creditors, including original creditors and debt buyers, to systemically use a file containing information on multiple consumer accounts to create account-level documents along with free online consumer access to those documents, to confirm the final resolution or settlement of one or more consumer debt accounts. The automated process may protect consumers by providing account-specific evidence that can be used to demonstrate to parties such as debt collectors, creditors, credit reporting agencies or courts that a debt has been fully satisfied (e.g., paid in full, settled in full, or cancelled). This evidence is often needed in response to disputes related to attempts to collect an account that has been paid or settled due to issues such as data or timing errors by a creditor or debt collector, or is needed to challenge claims by unscrupulous or fraudulent collectors seeking to collect old debts consumers may not remember or cannot otherwise substantiate. The extinguishment process and system may protect creditors from unnecessary service inquiries and the associated regulatory and reputational risk from inadvertent data errors or when fraudulent collectors pursue their former customers. The extinguishment innovative transaction-level process provides a cost effective approach to create extinguishment reports at an account level using files containing any number of accounts, from a single account to millions of accounts in one batch file. The flexible process supports files that may include accounts with different asset types, different extinguishment reasons and different extinguishment dates.

In one aspect, a system for debt extinguishment includes a server comprising a computer, a database accessible by the server, an account creation and registration subsystem executing on the server that permits at least one debt owner to upload account information to the database, the account information containing identifying information related to at least one debt that is extinguished, including a date of extinguishment, and an identity of at least one debtor associated with the at least one debt, a confirmation document handler subsystem executing on the server that electronically conveys a document to the debt owner to electronically sign for confirmation of extinguishment of the at least one debt, a search engine executing on the server accessible by the at least one debt owner and the at least one debtor, the search engine subsystem configured to search for debt accounts including extinguished debt accounts and a report generator subsystem executing on the server that generates a credit report or a report of extinguished debt to the at least one debt owner or the at least one debtor. The search engine subsystem may be configured to search for at least one extinguished debt account related to the at least one debt owner. The search engine subsystem may be configured to search by account number for multiple records related to the at least one debt. The database may maintain a record of extinguishment for the at least one debt as evidence of satisfied debt for the at least one debtor or the at least one debt. The report generator subsystem may output documents to evidence extinguishment of the at least one debt, a date of extinguishment of the at least one debt and identification of the debtor. The server may receive the electronically signed document for confirmation of extinguishment of the at least one debt over a network and stores the electronically signed document in the database. The at least one debt owner may be a plurality of debt owners and the at least one debtor may be a plurality of debtors. The database may be accessible to each debtor and each debt owner for searching for a record related to at least one extinguished debt related to the each respective debt owner.

In one aspect, a computer program product embodied on a non-transitory storage medium that, when read and executed by a computer, may perform the steps for a method of debt extinguishment comprising: receiving a file over a network at a server comprising at least one record related to account information of at least one debt related to at least one debtor and storing the at least one record in a database, confirming over a network with at least one debt owner that at least one account related to the at least one debt is extinguished and recording the confirmation in the database and generating a report and providing the report over the network, the report may include identification of the at least one account and a date of extinguishment. The computer program product may further perform receiving a search request over the network to locate the at least one record and the confirmation in the database. The computer program product may further perform sending results of the search request over the network and displaying report of a history of the at least one record. The computer program product may further perform generating a report that may be in response to a request by the at least one debtor or the at least one debt owner. The computer program product may further include validating the account information received over the network with a registered account in the database and is owned by an entity submitting the file. The computer program product may further include performing exception processing when the received account information does not match a registered account by contacting the entity submitting the file.

The computer program product may further include automatically registering a debt owner when the received account information does not match a registered account, the received account information including identification of the at least one debtor, debt owner name and date of origination of the debt. The confirming step may include receiving an electronic signature from the at least one debt owner over a network to confirm the at least one debt is extinguished. The step of generating a report may include identifying multiple accounts in the database that have been extinguished. The computer program product may further include maintaining the at least account related to the extinguished at least one debt in the database for more than a legal statute of limitation duration.

Additional features, advantages, and embodiments of the disclosure may be set forth or apparent from consideration of the detailed description and drawings. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and, together with the detailed description, serve to explain the principles of the disclosure. No attempt is made to show structural details of the disclosure in more detail than may be necessary for a fundamental understanding of the disclosure and the various ways in which it may be practiced. In the drawings:

FIG. 1 is an example flow diagram of a consumer debt extinguishment process, the steps performed according to principles of the disclosure;

FIG. 2 is an example block diagram and example process relationship and sequence for access to consumer debt extinguishment documentation, according to principles of the disclosure;

FIG. 3 is an example block diagram of an illustrative computer-based system suitable for performing the processes of FIGS. 1 and 2, configured according to principles of the disclosure; and

FIG. 4 is an example block diagram of software subsystems, configured according to principles of the disclosure.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, cell phone, notebook computers, desktop computers, workstation computers, servers, or the like. Further, the computer may include an electronic device configured to communicate over a communication link. The electronic device may include, for example, but is not limited to, a mobile telephone, a personal data assistant (PDA), a mobile computer, a stationary computer, a smart phone, mobile station, user equipment, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. At least one application may include, but is not limited to, for example, an application program that can accept connections to service requests from clients by sending back responses to the clients. The database may be configured to run at least one application, often under heavy workloads, unattended, for extended periods of time with minimal human direction.

A “network,” as used in this disclosure, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. The medium may be non-transitory. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other non-transitory storage medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

The “Extinguishment” process and system as described herein may enable creditors, including original creditors and debt buyers, to systemically use a file containing information related to one or multiple consumer accounts to create account-level documents along with free online consumer access to those documents, to confirm the final resolution or settlement of one or more consumer debt accounts. The automated process may protect consumers by providing account-specific evidence that can be used to demonstrate to parties such as, e.g., debt collectors, creditors, credit reporting agencies or courts that a debt has been fully satisfied, e.g., paid in full, settled in full, or cancelled. This evidence is often needed in response to disputes related to attempts to collect an account that has been paid or settled due to issues such as data or timing errors by a creditor or debt collector, or is needed to challenge claims by unscrupulous or fraudulent collectors seeking to collect old debts consumers may not remember or cannot otherwise substantiate. The extinguishment process and system may protect creditors from unnecessary service inquiries and the associated regulatory and reputational risk from inadvertent data errors or when fraudulent collectors pursue their former customers. The innovative transaction-level process herein may provide a cost effective approach to create extinguishment reports at an account level using files containing any number of accounts from a single account to millions of accounts in one batch file. The flexible process supports files that may include accounts with different asset types, different extinguishment reasons and different extinguishment dates.

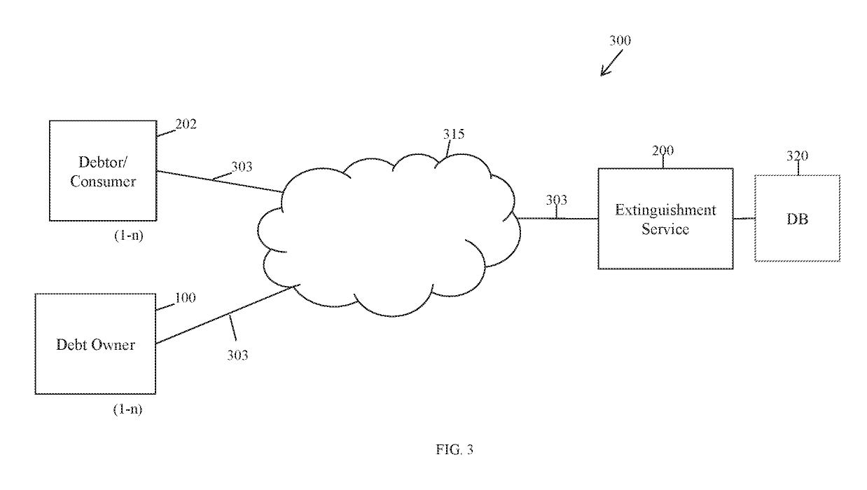

FIG. 3 for is an example block diagram of an illustrative computer-based system 300 suitable for performing consumer debt extinguishment processes described herein, configured according to principles of the disclosure. The system 300 may comprise one or more consumer devices 202 that may be a device that includes a computer, such as, e.g., a mobile computing device, a personal computer, a tablet computer, or the like. The one or more consumer devices 202 (which may be used by one or more associated debtors herein) may be connected by a communication link 303 to a network 315, which may be the Internet, to an extinguishment service 200, which may comprise a server. One or more debt owner devices 100 (which may be used by one or more associated debt owners), which may comprise a device that includes a computer, such as, e.g., a mobile computing device, a personal computer, a tablet computer, or the like, for use by a debt agency, a bank, a credit card company, or similar debt owner entity, may be connected by a communication link to the network 315 to the extinguishment service 200.

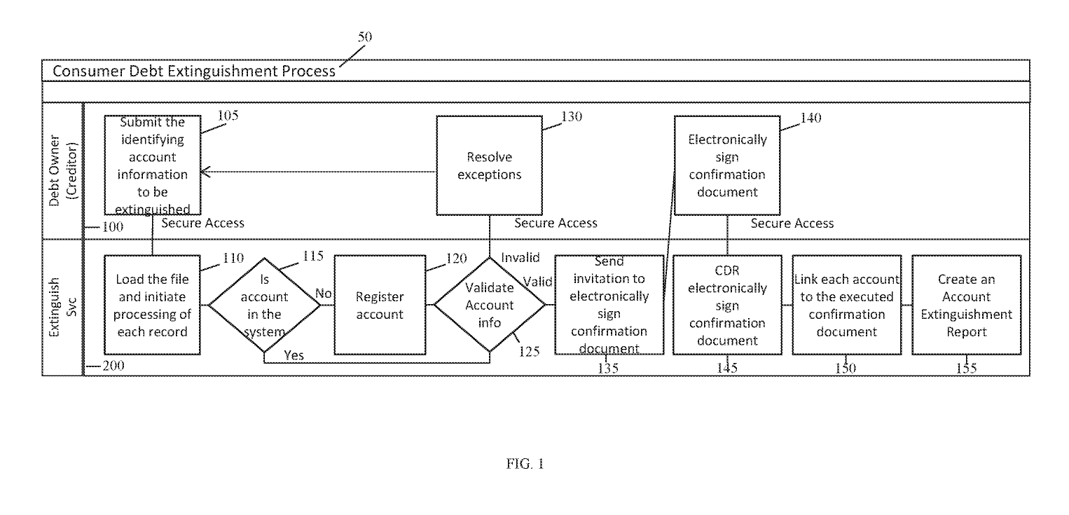

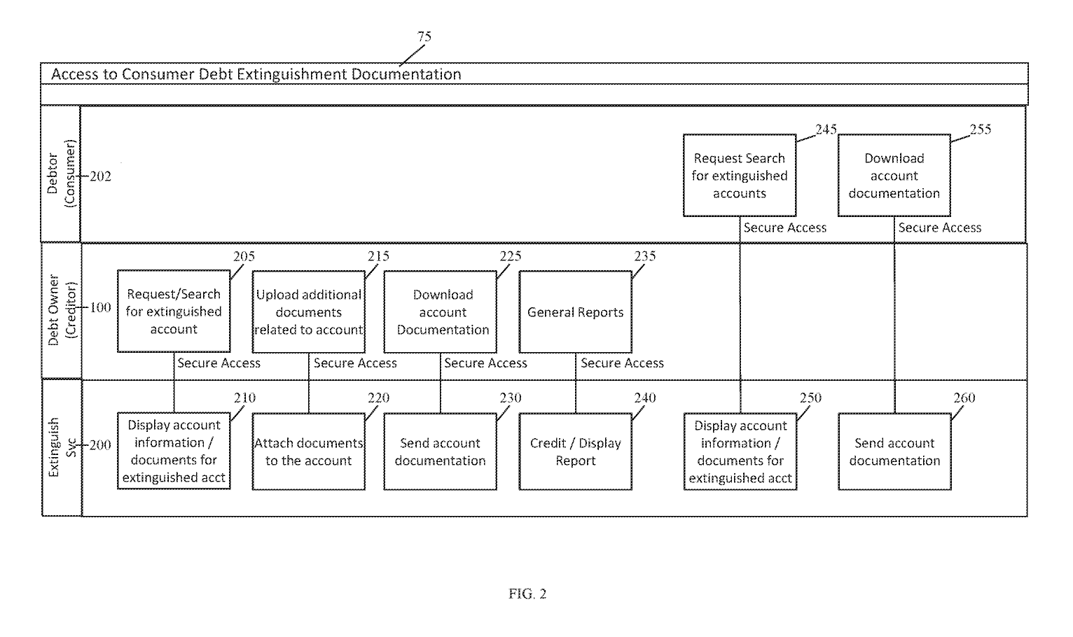

The extinguishment service 200 may be configured to communicate with consumers via devices 202 and debt owners via debt owner devices 100 over the network 315 in order to perform the services and steps described more fully below, in particular certain steps described in relation to FIGS. 1 and 2. Moreover, the extinguishment service 200 may include several software components or modules executable by the extinguishment service 200 server, such as those software components described in relation to FIGS. 1 and 2. The extinguishment service 200 may communicate with an account database 320 to establish, maintain and correlate records of consumer debt accounts and debt owner information, as described more below.

FIG. 1 is an example flow diagram of a consumer debt extinguishment process, the steps performed according to principles of the disclosure. The flow diagram 50 of FIG. 1 shows progression of a process for a debt owner 100 and also an extinguishment service 200. At step 105 a debt owner 100 (“creditor”) may submit a file, such as a CVS (a type of file extension) file, containing account information to be extinguished. This information may include identifying information sufficient to accurately identify the account by identifiers such as account number and also the debtor identification information including, e.g., name and address. The file may be uploaded to the extinguishment service 200 through a secure transaction service such as a Secure File Transfer Protocol (SFTP) or similar service. The extinguishment file includes information identifying the account or accounts to be extinguished and the effective date of the extinguishment. The file may include the reason for the extinguishment of each account, e.g., it was paid, settled or cancelled. Creditors may also include other optional information such as the last payment date and last payment amount. The information of the file may be stored in database 320 which may be, e.g., a SQL database, to create a registry in the database 320.

At step 110, the extinguishment service 200 uploads the file and may initiate processing of each record. At step 115, a check is made to determine if an account in the extinguishment file has been previously entered into the registry (i.e., “Registered”), the extinguishment file may include data to match an account with an account in the Registry. For example, submitted files may include one or more identifying numbers for each account such as the loan account number, a reference number used by the creditor, or the account tracking number created when the account was registered. Additionally, the submitted file can include one or more data fields identifying the consumer or debtor such as the person's name or some or all of the debtor's social security number.

At step 125, the account information may be validated. The extinguishment service 200 may confirm that each account matches a single registered account in its database 320 and that it is owned by the submitting creditor. Any account not matching this criteria is removed from processing via an exception file, and at step 130, the exception may be resolved with the debt owner 105.

If the check at step 115 determines that the submitted file information has not been registered, the submitted file must contain certain additional information for each account to simultaneously register (step 120) and extinguish the account. For example, the file must include the account type, account number or reference number, original creditor name, date of origination, and the name and address of the consumer and some or all of the consumer's social security number. The file can contain many additional fields related to the account as well. The registration of the account may include an attestation by the creditor that it is the legal owner of the account or accounts to be extinguished.

The received extinguishment file can include accounts with different asset classes such as credit card accounts, automobile loans, student loans, medical accounts or utility accounts. The extinguishment file can also include accounts with different extinguishment dates including accounts that may have been paid, settled or cancelled at any time in the past.

After the extinguishment service 200 confirms a match of one or more of the submitted accounts at step 125, then at step 135, the extinguishment service 200 may send an invitation to a creditor 100 to sign a confirmation document. The creditor 100 may receive the electronic invitation to electronically sign the confirmation document. The confirmation document summarizes the aggregate number of accounts in the submitted file and the presence of valid data entries for certain data fields. The confirmation document is a single document representing all of the accounts in the file to be extinguished and includes reference to the extinguishment service 200 transaction identification for the file containing the account level information. At step 140, the submitting creditor 100 may electronically sign the document confirming the submitter's extinguishment of the identified accounts in the transaction file. After the creditor electronically signs the document, at step 145, extinguishment service 200 may electronically sign the document as a witness. At step 150, the executed document may then be electronically linked to each of the accounts in the file, i.e., there is only one executed transaction document for a file and that one document is available to each of the individual accounts in the file.

The submitting creditor may use a Secure File Transfer Protocol (SFTP), upload process (or similar process) to load account-specific documentation it may have related to the accounts to be extinguished. Documents can be any file type or size. Documents may include account applications and statements, customer correspondence related to the release of the obligation, or records such as Form 1099c. The submitter may use an agreed upon account key in the file name to enable the extinguishment service 200 to match the documents to a specific account. For example, the file name may include the account number and type of document. The documents can be added to the account profile and data at any time after an account has been registered including after it has been extinguished. If a file name includes an account number and/or social security number, the extinguishment service 200 may create a new file name using a hashed value for the personally identifiable information.

At step 155, at the account level, the extinguishment service 200 may create an Account Extinguishment Report summarizing the information in the extinguishment service 200 Registry related to the account including information about the account number and original creditor, the debtor's name and address, its status as extinguished, and the date and reason (if provided) for the extinguishment. The extinguishment service 200 generated Account Extinguishment Report, the electronically signed extinguishment document signed by the creditor, the extinguishment service 200, plus any additional documentation provided by the submitting creditor, is stored in the extinguishment service 200 Registry on database 320 at the account level and made available to the creditor 100, its authorized agencies and to the consumer 202. This combination of documentation represents the Extinguishment documents.

FIG. 2 is an example block diagram and example process relationship and sequence for access to consumer debt extinguishment documentation, according to principles of the disclosure. In the flow diagram 75, the submitting creditor 100 and/or its authorized collection agencies can search, view and download information and documents on extinguished accounts through a secure password protected web application (step 205). Consumers or debtors 202 can search, view and download information through a separate secure web application at no cost (step 245). For example, consumers can search for account information on the extinguishment service 200 web service by entering an account number or reference number, last four numbers of the person's social security number and the person's last name.

At optional steps 210 and/or 250, account information may be displayed to the respective requestor, i.e., creditor 100 or consumer 202. At step 215, a creditor 100 may upload additional documents related to an account. At step 220, those uploaded documents may be attached to a proper account at the Registry.

At optional step 225, a creditor 100 may request to download account information. At step 230, the extinguishment service 200 may send the requested account information to the creditor 200. At optional step 235, a creditor 100 may request one or more reports to be generated. At step 240, the extinguishment service 200 may generate and display (and/or send) the requested report to the creditor 100.

At step 255 a consumer 202 may request a download of account documentation. This documentation may be the evidence to demonstrate prior extinguishment of a debt. At step 260, the extinguishment service 200 may provide the requested documents to demonstrate the status and/or extinguishment of a debt or account.

The extinguishment documents may be maintained in the extinguishment service 200 database 320 for as long as legally permissible. The extinguishment service 200 is not a credit reporting agency, and the extinguishment service 200 does not furnish the information to a credit reporting agency. As a result, the information is intended to remain available to consumers for 10 or more years, well beyond the statute of limitations in all states and past the time when the account must be removed from a credit reporting agency. This long-term availability provides consumers and creditors extra protection since it prevents efforts to collect on very old debt when account records may be otherwise unavailable.

Value to Consumers: the system and method herein may provide on-line access to a permanent record of the extinguishment of a debt account which may protect consumers from future collection efforts related to the account and may provide ready access to documents necessary to dispute or resolve claims or reports related to the account.

Value to Creditors: the systemic cost-effective process for extinguishing portfolios of accounts creates the first consumer debt collection industry database for consumers, creditors and debt owners to access documents to resolve disputes and counter claims by collectors attempting to collect payment on a consumer debt account that has already been paid, settled or cancelled. The process enables creditors to systematically extinguish mass numbers of accounts without the cost of postage or individual handling or servicing.

The system 300 and methods herein may permit secure, independent access to data and documents, e.g., stored at database 320, on non-performing consumers from more than one creditor or debt owner. Moreover, the database 320 may provide a permanent repository that may not be limited by statute of limitations. Further, the system 300 and methods herein may provide two-way secure sharing of confidential information (data and documents) between a debtor and a creditor including secure sharing by debt owners to associated authorized agencies or firms to support resolution of a dispute or debt. The database 320 may restrict access to anyone except the debt and the current debt owner or that debt owner's authorized agent.

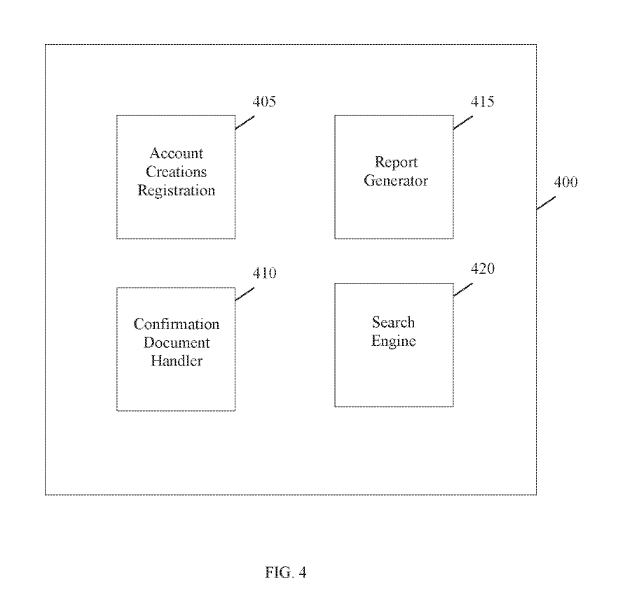

FIG. 4 is a block diagram of a software system 400 that may be employed to provide the functionality of the extinguishment service 200. The accounts creations/registration subsystem 405 may provide the controls to receive and load account information and initiate processing of records associated with information to be extinguished. The accounts creations/registration subsystem 405 may include the components associated with performing one or more of, e.g., steps 105, 110, 115, 120, 125, 130, 215 and 220. The confirmation document handler subsystem 410 may include the components associated with performing one or more of, e.g., steps 135, 140, 145 and 150. The report generator subsystem 415 may include the components associated with performing one or more of, e.g., steps 155, 235 and 240. The search engine subsystem 420 may include components associated with performing one or more of, e.g., steps 205, 210, 225, 230, 245, 250, 255 and 260. In some embodiments, the various steps of FIGS. 1 and 2 may be associated with another subsystem.

FIGS. 1 and 2 may also represent a block diagram of the components configured to performing the respective steps. The components may be software modules that, when read from a computer-readable medium, e.g., a computer-readable non-transitory storage medium, and executed by a computer, e.g., a server, perform the respective steps. The software modules may be stored on the computer-readable medium and may comprise computer program product.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed:

1. A system for debt extinguishment, comprising:
a server comprising a computer;
a database accessible by the server;
an account creation and registration subsystem executing on the server that permits at least one debt owner to upload account information to the database, the account information containing identifying information related to at least one debt that is extinguished including a date of extinguishment, and an identity of at least one debtor associated with the at least one debt;
a confirmation document handler subsystem executing on the server that electronically conveys a document to the debt owner to electronically sign for confirmation of extinguishment of the at least one debt;
a search engine subsystem executing on the server accessible by the at least one debt owner and the at least one debtor, the search engine subsystem configured to search for debt accounts including extinguished debt accounts; and
a report generator subsystem executing on the server that generates a credit report or a report of extinguished debt to the at least one debt owner or the at least one debtor.

2. The system of claim 1, wherein the search engine subsystem is configured to search for at least one extinguished debt account related to the at least one debt owner.

3. The system of claim 1, wherein the search engine subsystem is configured to search by account number for multiple records related to the at least one debt.

4. The system of claim 1, wherein the database maintains a record of extinguishment for the at least one debt as evidence of satisfied debt for the at least one debtor or the at least one debt.

5. The system of claim 1, wherein the report generator subsystem outputs documents to evidence extinguishment of the at least one debt, a date of extinguishment of the at least one debt and identification of the debtor.

6. The system of claim 1, wherein the server receives the electronically signed document for confirmation of extinguishment of the at least one debt over a network and stores the electronically signed document in the database.

7. The system of claim 1, wherein the at least one debt owner is a plurality of debt owners and the at least one debtor is a plurality of debtors, the database accessible to each debtor and each debt owner for searching for a record related to at least one extinguished debt related to the each respective debt owner.

8. A computer program product embodied on a non-transitory storage medium that, when read and executed by a computer, performs the steps for a method of debt extinguishment comprising:
receiving a file over a network at a server comprising at least one record related to account information of at least one debt related to at least one debtor and storing the at least one record in a database;
confirming over a network with at least one debt owner that at least account related to the at least one debt is extinguished and recording the confirmation in the database; and
generating a report and providing the report over the network, the report includes identification of the at least one account and a date of extinguishment.

9. The computer program product of claim 8, further comprising receiving a search request over the network to locate the at least one record and the confirmation in the database.

10. The computer program product of claim 9, further comprising sending results of the search request over the network and displaying report of a history of the at least one record.

11. The computer program product of claim 8, wherein the step of generating a report is in response to a request by the at least one debtor or the at least one debt owner.

12. The computer program product of claim 8, further comprising validating the account information received over the network with a registered account in the database and is owned by an entity submitting the file.

13. The computer program product of claim 12, further comprising performing exception processing when the received account information does not match a registered account by contacting the entity submitting the file.

14. The computer program product of claim 12, further comprising automatically registering a debt owner when the received account information does not match a registered account, the received account information including identification of the at least one debtor, debt owner name and date of origination of the debt.

15. The computer program product of claim 8, wherein the confirming step includes receiving an electronic signature from the at least one debt owner over a network to confirm the at least one debt is extinguished.

16. The computer program product of claim 8, wherein the step of generating a report includes identifying multiple accounts in the database that have been extinguished.

17. The computer program product of claim 8, further comprising maintaining the at least one account related to the extinguished at least one debt in the database for more than a legal statute of limitation duration.
